(19) United States
(12) Patent Application Publication
(10) Pub. No.: US 2005/0042963 A1
(43) Pub. Date: Feb. 24, 2005

(54) Method for the production of support materials, support materials produced according to said method and use of said support materials

(76) Inventors: Achim Adam, Nauheim (DE); Stefan Fuchsberger, Eltville (DE); Joachim Schluter, Wiesbaden (DE)

Correspondence Address: Robert L Stearns;Howard & Howard Attorneys, 39400 Woodward Avenue, Bloomfield Hills, MI, 48304, US

(21) Appl. No.: 10/490,910

(22) PCT Filed: Sep. 24, 2002
(86) PCT No.: PCT/DE02/03609

(30) Foreign Application Priority Data
Sep. 26, 2001 (DE) 101 47 302.8

(51) Int. Cl. B32B 27/00; D04H 1/00; B32B 15/14; D04H 3/00

(52) U.S. Cl. 442/376; 428/422; 428/412; 442/377; 442/394; 442/389

(57) ABSTRACT

Disclosed is a method for the production of support materials, wherein a web of a metal support fabric is continuously provided with a sliding layer covering the support fabric on one side and predominately containing polytetrafluorethylene (PTFE). The support fabric is coated with a paste made of the material of the sliding layer and one side of said support fabric is guided in full contact with another web of material during the coating process.

The present invention relates to a method of producing bearing materials having the features of the precharacterizing clause of claim 1, the bearing materials produced using this method and the use thereof.

In order to produce materials for composite bearings, which are provided with a plastics overlay, it is known to provide a plastics overlay on a solid, especially strip-form backing framework, preferably of steel, a copper and/or aluminum alloy, wherein this plastics overlay comprises as base material polytetrafluoroethylene (PTFE), to which further additions are optionally added, for example further polymers or wear- and/or friction-reducing additives. An overlay dispersion or paste is applied uniformly to this solid metallic backing framework, which in DE 11 32 710 AS is also known as a porous metal strip, with the assistance of a roll pair arranged downstream, such that the solid backing framework coated in this way may then be subjected to heat treatment.

It is also known to use a metallic backing fabric instead of the backing framework described above, which fabric is provided with an overlay covering one side of the backing fabric and containing mainly polytetrafluoroethylene. In order to produce this known backing fabric, a method is used in which a web of the metallic backing fabric is provided continuously with a film applied to one side of the backing fabric, which film contains the overlay material. In the known method, the backing fabric covered in this way with the film is then guided through a press, such that the film is pressed into the fabric structure of the backing fabric on one side.

The known method described above has the disadvantage, however, that the films of overlay material required therefor can only be produced with a relatively large amount of effort, such that the bearing materials produced by this method have a relatively high production price.

The object of the present invention is to provide a method of producing bearing materials of the type indicated, with which a metallic backing fabric may be provided particularly simply and continuously with an appropriate overlay.

This object is achieved according to the invention by a method having the characterizing features of claim 1.

As with the above-mentioned prior art, tie method according to the invention for producing bearing materials likewise provides for a web of a metallic backing fabric to be provided continuously with an overlay covering the backing fabric on one side and mainly containing polytetrafluoroethylene (PTFE), wherein, in contrast to the above-stated prior art, the backing fabric is not coated with a film but instead with a paste of the overlay material. In the method according to the invention, the backing fabric is guided during coating in all-over contact oil one side with a further web, in such a way that, during coating, the overlay material paste is applied to the one upper side, which is hereinafter also abbreviated to top face, of the backing fabric, while the opposing surface, hereinafter also abbreviated to bottom face, of the backing fabric is guided during this coating process in all-over contact with a further web, such that the further web thus lies close against the bottom face of the backing fabric.

The method according to the invention exhibits a number of advantages. For instance, it should first of all be noted that the method according to the invention, in contrast to the above-described known method in which a film containing the overlay material is applied to the metallic backing fabric, allows substantially more reasonably priced production of bearing materials, especially since the method according to the invention is a single-stage method and dispenses completely with the separate production of a film. Furthermore, the method according to the invention simplifies variation of the possible overlay materials and multiplies the range thereof, since in the known method corresponding films cannot be made from all the possible overlay materials and since, moreover, with the method according to the invention the production of such films is dispensed with completely. Because with the method according to the invention the pasty overlay material is applied directly to the metallic backing fabric, not only the composition of the overlay but also the thickness thereof may be varied as desired without great effort, which is likewise not possible in the above-mentioned prior art. It has surprisingly been noted that only the above-described one-sided all-over contact between the further web and the bottom face of the backing fabric during coating effectively prevents pasty material and exuded water from passing undesirably through to the bottom face of the backing fabric, as was always the case with direct coating of the backing fabric with the pasty overlay material, i.e. without the provision of a corresponding further web. Application of the method according to the invention therefore makes possible simple and problem-free production of a backing fabric properly provided with an overlay mainly on one side.

In the context of the present description, the term backing fabric covers all structures which are especially distinguished in that openings are provided between the bottom face and the top face, through which the pasty material applied to the top face may penetrate through to the bottom face during coating.

The term coating denotes all application methods with which a predetermined and adjustable amount of pasty overlay material may be applied to the backing fabric, in particular pouring, spreading and/or spraying of the pasty material, in particular using appropriate coating knife and nozzle systems. Furthermore, this term coating also in particular covers application of the pasty overlay material by means of at least one roll and preferably by means of two rolls, wherein one roll or both rolls apply the pasty overlay material to the backing fabric and there at the same time distribute it evenly on the top face and into the openings.

A particularly suitable first embodiment of the method according to the invention is characterized in that the web of backing fabric is guided together with the further web in all-over contact through the nip of a calender to coat the backing fabric with the pasty overlay material. This nip has the effect that on the one hand, application of the pasty overlay material is rendered uniform and reproducible while, on the other hand, the amount of pasty material applied and the degree of penetration thereof may be varied by varying the linear pressure. The further web lying underneath in all-over contact ensures that no water is discharged at the underside (bottom face) of the backing fabric, which would prevent uniform distribution of the pasty material on the top backing fabric face.

In order to assist still further the above-described advantageous effects of the further web in the method according to the invention, a second, particularly preferred embodiment of the method according to the invention is characterized in that a web with a rough surface is selected as the further web.

This is particularly the case when a web is selected as further web whose surface facing the backing fabric, i.e. thus the surface which comes into contact with the bottom face of the backing fabric during coating, is provided with particles and/or unevennesses of the order of between 5 μm and 50 μm, preferably with particles and/or unevennesses of the order of between 10 μm and 30 μm. This surface of the further web comprises the above-mentioned particles or unevennesses in a uniform distribution. By selecting such a further web, whose surface exhibits uniform roughness produced by the particles or unevennesses, it is possible to prevent particularly effectively and reproducibly the above-described discharge of liquid, especially water, on the underside during the coating process.

Unevennesses are understood to mean regular or irregular surface texturing which may be produced by appropriate mechanical or other treatment, for example by laser beam treatment. Rough surfaces may also be distinguished in that corresponding fibers or fiber bundles project from the surface, as is the case when using a textile further web. The further web particularly preferably exhibits a surface roughness which varies especially between 5 μm and 50 μm and preferably between 10 μm and 30 μm.

With regard to the material of the further web, it should be noted that webs of paper, plastics, textiles or metal are especially selected therefor which are dense enough for the duration of the coating process not to allow any water to pass through, and are capable of clinging completely to the underside of the strip without themselves giving too markedly. When using webs of paper or textiles, it would seem preferable for the surface of this web, which comes into contact with the bottom face of the backing fabric, to be hydrophobic, which may be achieved simply and without difficulty for example by appropriate coatings or by selecting hydrophobic fibers.

In order, in the case of the method according to the invention, to produce the above-described roughness and/or the particles on the surface of the further web, a further embodiment of the method according to the invention is characterized in that the corresponding surface, which comes into contact with the bottom face of the backing fabric during coating, is sandblasted to form the roughness and/or the particles, wherein the desired roughness of the surface of the further web may be set particularly simply and without difficulty by the intensity of the sandblasting, the grain size selected therefor and the exposure time.

In order, in the case of the method according to the invention, to ensure the necessary, above-described water-impermeability and/or hydrophobia at least of the surface of the further web, the farther web especially takes the form of a film of biaxially oriented polyester or of biaxially oriented polycarbonate, wherein such a film in itself exhibits the water-impermeability necessary for preventing the undesired discharge of water or other liquid via the bottom face of the backing fabric. Furthermore, these films also have the advantage that they exhibit not only excellent strength due to their biaxial orientation but also chemical resistance, such that a further web consisting of such a film has a long service life.

As far as the thickness of the further web is concerned, and in particular the thickness of the above-described plastics webs, it should be noted that the thickness of these webs also depends in particular on the material thereof wherein web thicknesses ranging between 50 μm and 500 μm, preferably between 100 μm and 400 μm, are particularly advantageous and may be used repeatedly.

As stated repeatedly above with regard to the method according to the invention, a paste of the material constituting the overlay is applied to the backing fabric in the method according to the invention. In order to adjust the consistency of this paste to the respective backing fabric, which may exhibit different densities due to different backing fabric constructions, a different amount of liquid, for instance water in particular, is added to the material. However, it is particularly suitable, in the case of the method according to the invention, for a wetting agent to be additionally added to this water, in order thus to set the desired consistency of the paste even without the addition of an organic solvent. A non-ionic wetting agent, ad preferably a wetting agent based on an alkyl polyglycol ether, is in particular selected therefor, wherein, however, other wetting agents, for example in particular alkylaryl polyglycol ethers, alkylamine polyglycol ethers, alkylamine oxides and/or fatty acid esters of polyalcohols, may also be used.

In order to vary the desired properties of the overlay produced on one side of the backing fabric, another development of the method according to the invention is characterized in that the overlay material paste contains, in addition to polytetrafluoroethylene (PTFE), at least one other polymer, preferably at least one high temperature-resistant polymer.

In the above-described development of the method according to the invention, the high temperature-resistant polymer preferably comprises a polymer selected from the group comprising fully aromatic polyesters, fully aromatic polyamides, polyetherether ketones and/or polyphenylene sulfones.

If it is desired, using the method according to the invention, to produce particularly temperature-resistant overlays with a particularly high load-carrying capacity on one side of the backing fabric, another embodiment of the method according to the invention is characterized in that a paste is selected which contains, in addition to polytetrafluoroethylene (PTFE), between 20 vol. % and 60 vol. % of the high temperature-resistant polymer, especially the above-mentioned polymers.

In addition, the method according to the invention provides the possibility of replacing a proportion of the polytetrafluoroethylene, preferably up to 50 vol. % of the polytetrafluoroethylene (PTFE), with other polymers and especially with poly(tetrafluoroethylene-co-perfluorovinyl methyl ether) (PFA), poly(tetrafluoroethylene-co-hexafluoropropylene) (FEP), poly(hexafluoroisobutylene-covinylidene fluoride) (CM-1), poly(ethylene-alt-tetrafluoroethylene) (ETFE) and/or polyvinylidene fluoride (PVDF), as proposed by a further development of the method according to the invention.

A further modification of the overlay arranged in one-sided mariner on the top face of the backing fabric is achieved in that, in a further development of the method according to the invention, an overlay material paste is used in which up to 50 vol. % of the high temperature-resistant polymer is replaced by molybdenum sulfide, tungsten sulfide, boron nitride, graphite, lead, lead oxide, iron oxides, calcium fluoride, glass and/or ceramic powder and/or glass and/or carbon fibers. Such a modification of the pasty material applied to the backing fabric allows the properties of the overlay to be adjusted effectively to the respective requirements, wherein it is merely necessary to produce appropriately pasty materials.

In principle, the method according to the invention provides two options for guiding the backing fabric during coating so that its bottom face is in one-sided all-over contact with a further web, wherein the first option is characterized in that the further web is fed to the coating step at the same time as the web of metallic backing fabric and the further web is then diverted from the web of metallic backing fabric and disposed of, optionally after coiling. Thus, with this first option the further web is used only once and then disposed of.

However, the second option is particularly advantageous, an endless loop of the farther web being provided under the backing fabric in the coating area, wherein this further web is then guided in such a way that it is in all-over contact with the underside of the backing fabric during the actual coating step. This further web, which is conveyed continuously like the backing fabric, is turned round and fed back to the coating step, wherein increased requirements are then made of such a further web especially with regard to strength and durability and to chemical resistance, since this further web is re-used many times.

In order to finish the bearing material produced using the method according to the invention, a further development of the method according to the invention is characterized in that, after coating of the backing fabric, the coated backing fabric is subjected to heat treatment, optionally after pre-drying, in order to fix the overlay permanently on the backing fabric. The final thickness and tolerance are then produced by means of further roll treatment. A cutting process may then optionally follow, for sizing the backing fabric provided on one side with the overlay, the backing fabric then being coiled for further processing, wherein both coating and heat treatment and also sizing are preferably performed continuously.

The present invention additionally relates to a beating material produced using one of the above-described embodiments of the method according to the invention, wherein the beating material according to the invention comprises a backing fabric which is provided on its one surface with an overlay predominantly of polytetrafluoroethylene and as far as possible has no overlay on its other surface.

The bearing material according to the invention is used especially as a sliding element in flanged bushes and preferably for vehicle door hinges, wherein special emphasis should be laid in particular on the favorable price of a bearing material produced in this way, in addition to its excellent long-term load-carrying capacity while retaining problem-free functioning.

All the concentrations stated in volume percent in this description relate to the finished overlay.

Advantageous further developments of the method according to the invention are indicated in the subclaims.

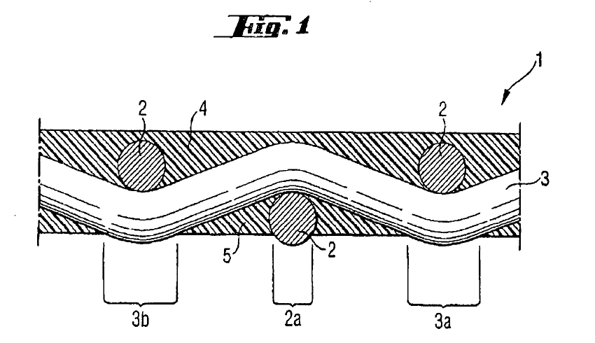

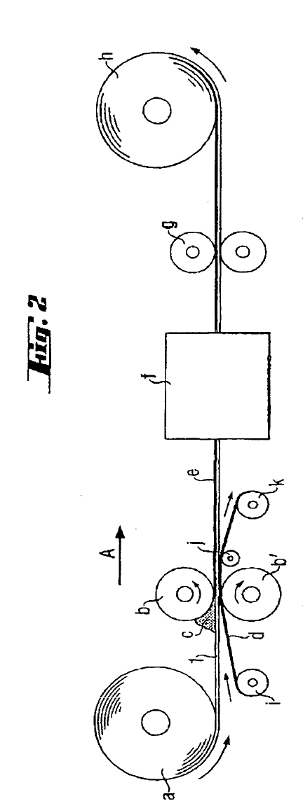

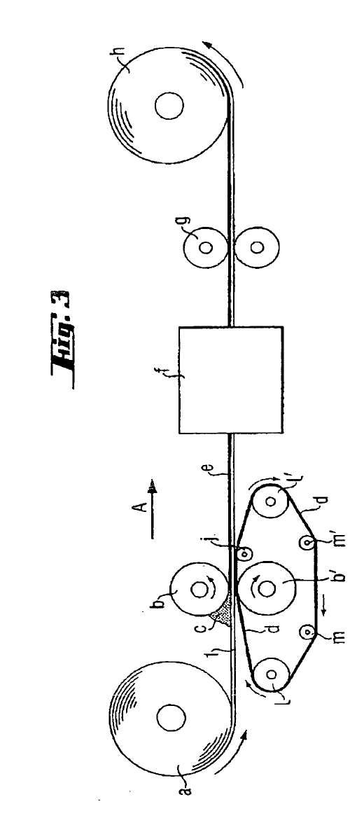

The bearing material according to the invention is explained in more detail below with reference to FIG. 1 and the method according to the invention is explained in more detail below with reference to two exemplary embodiments, illustrated schematically in FIGS. 2 and 3. In the Figures:

FIG. 1 is a schematic sectional view through a backing fabric provided on one side with an overlay;

FIG. 2 is a schematic representation of a first embodiment of the method according to the invention; and

FIG. 3 is a schematic representation of a second embodiment of the method according to the invention.

The backing fabric illustrated schematically in FIG. 1 and designated overall as 1 comprises a first thread system 3 and a second thread system 2 extending perpendicularly thereto, wherein the thread systems 2 and 3 consist of metal wires. The backing fabric 1 is provided on its surface with w overlay 4, wherein the overlay 4, which mainly contains polytetrafluoroethylene, covers the backing fabric 1 in one-sided manner as far as its top face is concerned and thus projects thereabove. The opposing bottom face is provided in part with the identical overlay material 5, wherein, however, the overlay 5, unlike the overlay 4, does not cover the bottom face of the backing fabric 1, such that parts of the thread systems 3a, 2a and 3b form the outer bottom face of the backing fabric 1.

In FIGS. 2 and 3 the same elements are provided with the same reference numerals.

The embodiment illustrated schematically in FIG. 2 of the method for producing bearing materials provides a supply roller a for the web of metallic backing fabric 1, wherein the roller a takes the form of an unwinding roller for the backing fabric 1. In the conveying direction of the backing fabric 1, which is identified by the arrow A, a calender is provided whose rolls b and b′ form a nip through which the backing fabric is guided for coating purposes. The upper roll b additionally has the effect of supplying a pasty material c, which forms the overlay on the backing fabric 1, continuously and in uniform quantities to the backing fabric 1. In the direction of arrow A, this is followed by a heat treatment device f, through which the backing fabric e provided with the paste is conveyed. Downstream thereof there is provided a further roll pair g, which bring the backing fabric provided with the overlay to a desired final thickness, before the fabric, in the form of a coated backing fabric, is coiled onto a take-up reel h.

In this respect the second exemplary embodiment illustrated in FIG. 3 does not differ from the above-described first exemplary embodiment.

However, the exemplary embodiment illustrated in FIG. 2 provides a further, following web d beneath the roll b, which web rests in the calendar nip fully against the underside of the backing fabric c provided with the paste. The further, following web d is drawn off from an unwinding roller i, conveyed through the nip, there guided for a predetermined distance still in contact with the coated backing fabric by means of the roller j and finally coiled onto the take-up roll k, wherein the material of the further web d is selected in such a way that it is for example a paper web which may be disposed off after being used once.

In contrast thereto, the second exemplary embodiment illustrated in FIG. 3 comprises an endless loop of further web d, wherein continuous conveying of this endless web loop is ensured by means of two deflection rolls I and I′ and two tensioning rolls m and m′. With the method shown in FIG. 3, the revolving web d is again fed continuously to the nip by means of the deflection roll I, such that its surface is guided through the nip in contact with the underside of the backing fabric. The roll j, already described above, ensures that this all-over contact is maintained downstream of the calender b, b′ for a given time. Since the loop of endless further web d shown in FIG. 3 is thus re-used, increased requirements are made of it with regard to strength, dimensional stability and chemical resistance, such that such a further web preferably consists of a polymeric material or a metal belt.

1. A method of producing bearing materials, in which a web of a metallic backing fabric is provided continuously with an overlay covering the backing fabric on one side and mainly containing polytetrafluoroethylene (PTFE), characterized in that the backing fabric is coated with a paste of the overlay material and in that the backing fabric is guided during coating in all-over contact on one side with a further web.

2. A method according to claim 1, characterized in that, for coating purposes, the web of backing baric is guided together with the further web through the nip of a calender.

3. A method according to claim 1, characterized in that a web with a rough surface is used as the further web.

4. A method according to claim 3, characterized in that a web is select3ed as further web whose surface facing the backing fabric is provided with uniformly distributed particles and/or unevennesses of the order of between 5 μm and 50 μm, preferably between 10 μm and 30 μm.

5. A method according to claim 1, characterized in that a web of paper, plastics, textiles or metal is selected as the further web.

6. A method according to claim 4, characterized in that the one surface of the further web is sandblasted to form the particles and/or the unevennesses.

7-18. (Cancelled).

19. A method according to claim 5, characterized in that the one surface of the further web is sandblasted to form the particles and/or the unevennesses.

20. A method according to claim 5, characterized in that a film of biaxially oriented polyester or biaxially oriented polycarbonate is selected as the further web.

21. A method according to claim 20, characterized in that the further web has a thickness of between 50 μm and 500 μm.

22. A method according to claim 1,characterized in that the consistency of the paste is adjusted solely by the addition of a wetting agent.

23. A method according to claim 22, characterized in that a non-ionic wetting agent is selected as wetting agent.

24. A method according to claim 23, chacterized in that the non-ionic wetting agent is based on alkyl polyglycol ether.

25. A method according to claim 1 characterized in that the overlay material paste contains, in addition to poytetrafluoroethylene (PTFE), also at least one high temperature-resistant polymer.

26. A method according to claim 25, characterized in that the at least one high temperature-resistant polymer is selected from the group consisting of fully aromatic polyesters, fully aromatic polyamides, polyetherether ketones and polyphenylene sulfones.

27. A method according to claim 25, characterized in that a paste is selected which comprises, in addition to polytetrafluoroethylene (PTFE), between 20 and 60 vol. % of the high temperature-resistant polymer.

28. A method according to claim 25, characterized in that up to 50 vol. % of the polytetrafluoroethylene (PTFE) is replaced by poly(tetrafluoroethylene-co-perfluorovinyl methyl ether) (PFA), poly(tetrafluoroethylene-co-hexafluoropropylene) (FEP), poly(hexafluoroisobutylene-covinylidene fluoride) (CM-1_, poly(ethylene-alt-tetrafluoroethylene) (ETFE) and/or polyvinylidene fluoride (PVDF).

29. A method according to claim 1, characterized in that an overlay material paste is selected in which up to 50 vol. % of the high temperature-resistant polymer is replaced by molybdenum sulfide, tungsten sulfide, boron nitride, graphite, lead, lead oxide, iron oxides, calcium fluoride, glass and/or ceramic powder and/or glass and/or carbon fibers.

30. A method according to claim 1, characterized in that the coated backing fabric is subjected to a heat treatment after coating thereof.

31. A bearing material having a backing fabric, wherein the backing fabric, produced by a method in which a web of a metallic backing fabric is provided continuously with an overlay covering the backing fabric on one side and mainly containing polytetraluoroethylene (PTFE), characterized in that the backing fabric is coated with a past of the overlay material and in that the backing fabric is guided during coating in all-overcontact on one side with a further web has on its one surface an overlay predominately of polytetrafluoroethylene (PTFE) and as far as possible has no overlay on its other surface.

32. A bearing material according to claim 31, characterized in that the web of paper, plastics, textiles or metal is selected as the further web.

33. A bearing material according to claim 32, characterized in that a film of diaxially oriented polyester or bi-axially oriented polycarbonate is selected as the further web.

34. A bearing material according to claim 33, characterized in that the further web has a thickness of between 50 μm and 500 μm.

35. A bearing material according to claim 31, characterized in that the overlay material paste contains, in addition to polytetrafluoroethylene (PTFE), also at least one high temperature-resistant polymer.

36. A bearing material according to claim 35, characterized in that the at least one high temperature-resistant polymer is selected from the group comprising fully aromatic polyester, fully aromatic polyamides, polyetherether ketones and polyphenylene sulfones.

37. A bearing material according to claim 31, characterized in that the a paste is selected which comprises, in addition to polytetrafluoroethylene (PTFE), between 20 and 60 vol. % of the high temperature-resistant polymer.

38. A method according to claim 35, characterized in that up to 50 vol. % of the polytetrafluoroethylene (PTFE) is replaced by poly(tetrafluoroethylene-co-perfluorovinyl methyl ether) (PFA), poly(tetrafluoroethylene-co-hexafluoropropylene) (FEP), poly(hexafluoroisobutylene-covinylidene fluoride) (CM-1_, poly(ethylene-alt-tetrafluoroethylene) (ETFE) and/or polyvinylidene fluoride (PVDF).

39. A bearing material according to claim 31, characterized in that and overlay material paste is selected in which up to 50 vol. % of the high temperature-resistant polymer is replaced by molybdenum sulfide, tungsten sulfide, boron nitride, graphite, lead, lead oxide, iron oxides, calcium fluoride, glass and/or ceramic powder and/or glass and/or carbon fibers.

40. A bearing material according to claim 31, wherein the bearing material is used as a sliding element in a flanged bushing.

41. A bearing material according to claim 40, wherein the flanged bushing is a component of a vehicle door hinge.
